(19) United States
(12) Patent Application Publication
(10) Pub. No.: US 2003/0084927 A1
(43) Pub. Date: May 8, 2003

(54) Washer and washing method

(75) Inventor: Hatsuo Yotsumoto, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/096,539

(22) Filed: Mar. 13, 2002

(30) Foreign Application Priority Data
Nov. 8, 2001 (JP) 2001-342958

(51) Int. Cl. B08B 3/04

(52) U.S. Cl. 134/36; 134/102.1; 134/109

(57) ABSTRACT

A washer has ozone dissolving equipment for dissolving ozone supplied from an ozone supply source into washing water, and a washing water reservoir for storing the washing water including the ozone and dipping a washed object into the stored washing water, wherein the washing water includes an alkali bromide. Thus, there are provided a washer and a washing method able to easily obtain the washing water of high concentration and lengthen the duration of washing ability.

### BACKGROUND OF THE INVENTION

1. Field of the Invention

This invention relates to a washer and a washing method for washing a washed object by decomposing and removing an organic substance by an oxidizing agent, and particularly used preferably in resist separation, organic substance removal and oxidation processing on a wafer surface in wafer washing in a semiconductor manufacturing process.

2. Description of the Related Art

As shown in Japanese Patent Laid-Open No. 2000-40683, a wafer, etc. were conventionally washed by ozone water manufactured by an ozone water manufacturing device. FIG. 7 shows a system flow of a conventional washer.

In this figure, reference numerals 101, 102 and 103 designate pure water supplied to an ozone water manufacturing device, the ozone water manufacturing device, and ozone water manufactured by the ozone water manufacturing device 102, respectively. Reference numerals 104, 105 and 106 designate a washing water reservoir for dipping and washing the wafer, etc., a hood for collecting an exhaust ozone gas from the washing water reservoir 104, and the exhaust ozone gas, respectively.

The ozone water 103 manufactured by the ozone water manufacturing device 102 is supplied to the washing water reservoir 104 into which the wafer, etc. are dipped. The ozone water 103 comes in contact with the wafer, and oxidizes, decomposes and removes an organic substance from the wafer surface. Since ozone dissolved by pressurization attains atmospheric pressure, the ozone water 103 supplied to the washing water reservoir 104 is deaerated so that ozone gas is generated. Since the ozone gas is poisonous, the ozone gas is collected by the hood 15 and is exhausted to the outdoors. The ozone water 103 supplied to the washing water reservoir 104 is overflowed from the washing water reservoir 104 after the wafer is washed. The ozone water 103 overflowed from the washing water reservoir 104 is collected and drained.

The conventional washer is constructed as mentioned above. Here, in a general manufacturing method of the ozone water, the ozone gas generated in an ozone generator is dissolved into pure water by a fine hollow body film module. However, in this method, when a pure water amount is increased, ozone concentration is reduced in performance of the film module. In contrast to this, when the ozone concentration is increased, it is necessary to reduce the pure water amount.

Accordingly, it was difficult to prepare a large amount of washing water of high ozone concentration.

Further, the half-life of the ozone water obtained by dissolving ozone into the pure water is about 15 to 20 minutes so that no washing ability can be continuously maintained for a long time.

This invention is made to solve the above problem, and an object of this invention is to provide a washer and a washing method able to easily obtain washing water of high concentration, and lengthen the duration of washing ability.

Further, another object of this invention is to provide a washer and a washing method for restraining an ozone odor around a washing water reservoir, and requiring no large exhaust equipment around the washing water reservoir.

Further, another object of this invention is to provide a washer and a washing method for effectively utilizing washing water and able to restrain a rise in running cost even when a large amount of washing water is required.

### SUMMARY OF THE INVENTION

A washer in this invention comprises ozone dissolving equipment for dissolving ozone supplied from an ozone supply source into washing water, and a washing water reservoir for storing the washing water including the ozone and dipping a washed object into the stored washing water, wherein the washing water includes an alkali bromide.

In the washer in this invention, the alkali bromide approximately has a concentration from 1 to 10%.

In the washer in this invention, the washer further comprises an alkali bromide supply source for supplying the alkali bromide to the washing water before this washing water flows into the ozone dissolving equipment.

In the washer in this invention, the washer further comprises a gas-liquid separator for separating the washing water flowed out of the ozone dissolving equipment into a gas and a liquid, and an ozone purifying device for purifying ozone separated into the gas phase.

In the washer in this invention, the washer further comprises diffusing equipment arranged within the washing water reservoir and diffusing the ozone from the ozone supply source into the washing water reservoir.

In the washer in this invention, the washer further comprises a washing water circulating path for supplying the washing water flowed out of the washing water reservoir to the ozone dissolving equipment.

A washing method in this invention comprises a step for supplying ozone to washing water including an alkali bromide, and a step for washing a washed object with a reaction product of the alkali bromide and the ozone.

In the washing method in this invention, the washing method further comprises a step for circulating the washing water used in the washing, and a step for again supplying ozone to this circulated washing water.

### BRIEF DESCRIPTION OF THE DRAWINGS

FIG. 1 is a system flow showing a washer of an embodiment 1.

FIG. 2 is a system flow showing a washer of an embodiment 2.

FIG. 3 is a system flow showing a washer of an embodiment 3.

FIG. 4 is a system flow showing a washer of an embodiment 4.

FIG. 5 is a system flow showing a washer of an embodiment 5.

FIG. 6 is a system flow showing a washer of an embodiment 6.

FIG. 7 is a system flow of a conventional washer.

### DETAILED DESCRIPTION OF THE PREFERRED EMBODIMENT

### Embodiment 1

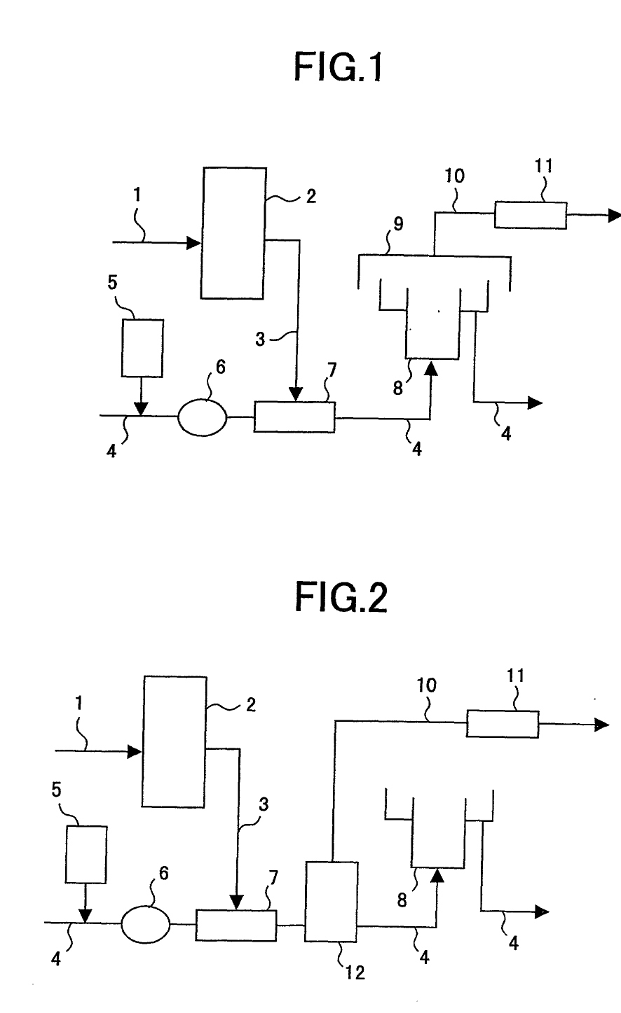

FIG. 1 is a system flow showing a washer of an embodiment 1. In FIG. 1, reference numerals 1 and 2 designate oxygen gas as a raw material of ozone gas, and an ozone gas generator for generating ozone by using the oxygen gas 1, respectively. The ozone gas generator 2 is an ozone supply source. Reference numerals 3 and 4 designate the ozone gas supplied from the ozone gas generator 2, and washing water using water (hereinafter called pure water) highly refined, respectively. Reference numeral 5 designates alkali bromide solution injecting equipment for injecting an alkali bromide to the washing water 4. The alkali bromide solution injecting equipment 5 is an alkali bromide supply source. Reference numerals 6 and 7 designate a pump for circulating the washing water 4, and a gas mixer constructed by an ejector, a mixer, etc. and efficiently mixing the ozone gas 3 with the washing water 4, respectively. The gas mixer 7 is ozone dissolution equipment. Reference numeral 8 designates a washing water reservoir for storing the washing water flowed out of the gas mixer 7 and dipping a washed object such as a wafer into this stored washing water. Reference numerals 9, 10 and 11 designate a hood for collecting the ozone gas discharged from the washing water reservoir 8, the collected exhaust ozone gas, and an exhaust ozone decomposing tower filled with a catalyst for decomposing the exhaust ozone gas 10 into harmless oxygen, respectively.

In the washer of the embodiment 1, the alkali bromide solution is injected to the washing water 4 by the alkali bromide solution injecting equipment 5. The washing water 4 including the alkali bromide is sent to the gas mixer 7 by the pump 6. In the gas mixer 7, the ozone gas 3 is mixed with the washing water 4. Here, an oxidizing agent acting similarly to ozone is generated by reacting the ozone gas 3 and the alkali bromide included in the washing water 4.

In the embodiment 1, the alkali bromide is typically represented by sodium bromide, potassium bromide, etc. For example, when the sodium bromide is used as the alkali bromide, hypobromous acid (Bro⁻) and bromic acid (Bro₃⁻) are generated as reaction products. These reaction products act as the oxidizing agent, and are effective to decompose and remove an organic substance.

Further, dissolution efficiency of the ozone gas into the alkali bromide is higher that that of pure water, and a dissolution efficiency of about 100% is obtained by increasing an adding amount of alkali bromide.

Accordingly, since the washing water 4 including the alkali bromide easily dissolves the ozone gas 3, it is possible to easily generate the washing water of high concentration of the oxidizing agent. Therefore, even when the washing water reservoir 8 is large-sized and a large amount of washing water is required as the wafer is large-sized, a large amount of washing water of high concentration can be prepared.

As mentioned above, the gas mixer 7 mixes the ozone gas 3 with the washing water 4 with high efficiency, and supplies this washing water 4 to the washing water reservoir 8. A washed object such as the wafer is dipped into the washing water 4 in the washing water reservoir 8. The organic substance on the surface of the washed object is decomposed and removed by the reaction products of the alkali bromide and ozone.

These reaction products are good in stability, and have a half-life of several hours although the half-life of ozone water obtained by including ozone in the pure water approximately ranges from 15 minutes to 30 minutes. Accordingly, washing ability for a long time is obtained in comparison with the ozone water.

The exhaust ozone gas 10 discharged from the washing water reservoir 8 is collected by the hood 9, and is decomposed into harmless oxygen by the exhaust ozone decomposing tower, and is then exhausted to the outdoors. The washing water used in the washing water reservoir 8 is overflowed and exhausted.

As mentioned above, in accordance with the embodiment 1, since the alkali bromide is included in the washing water, dissolution efficiency of the ozone gas into the washing water can be improved. Thus, it is possible to easily generate the washing water of high concentration of the oxidizing agent. Further, since the washing water of high concentration is easily generated, it is possible to cope with the requirement of a large amount of washing water.

Since the reaction products of the alkali bromide and ozone act as the oxidizing agent and have excellent stability, it is possible to have washing ability for a long time.

In this embodiment, a washing method is also explained by way of explaining the operation of the washer. This washing method is characterized in that the alkali bromide is included in the washing water prior to the ozone gas. Thus, dissolution efficiency of the ozone gas into the washing water can be improved.

### Embodiment 2

FIG. 2 shows a system flow showing a washer of an embodiment 2. In this figure, reference numeral 12 designates a gas-liquid separating reservoir as a gas-liquid separator. In the embodiment 2, an exhaust ozone decomposing tower 11 is an ozone purifying device for purifying ozone separated into a gas phase.

In the embodiment 2, washing water 4 flowed out of the gas mixer 7 is provided to the gas-liquid separating reservoir 12. The gas-liquid separating reservoir 12 separates the washing water 4 into an exhaust ozone gas 10 of the gas phase and washing water 4 of a liquid phase. The exhaust ozone gas 10 separated into the gas phase is decomposed into harmless oxygen by the exhaust ozone decomposing tower 11, and is exhausted to the system exterior. In contrast to this, the washing water 4 separated into the liquid phase is supplied to the washing water reservoir 8, and washes a washed object within the washing water reservoir 8.

Here, the ozone water has an ozone odor, but the reaction products of ozone and the alkali bromide are odorless. Accordingly, in accordance with the embodiment 2, an environment around the washing water reservoir can be improved.

Further, in accordance with the embodiment 2, since no exhaust equipment is required around the washing water reservoir, it is not necessary to arrange large exhaust equipment as the washing water reservoir is large-sized.

### Embodiment 3

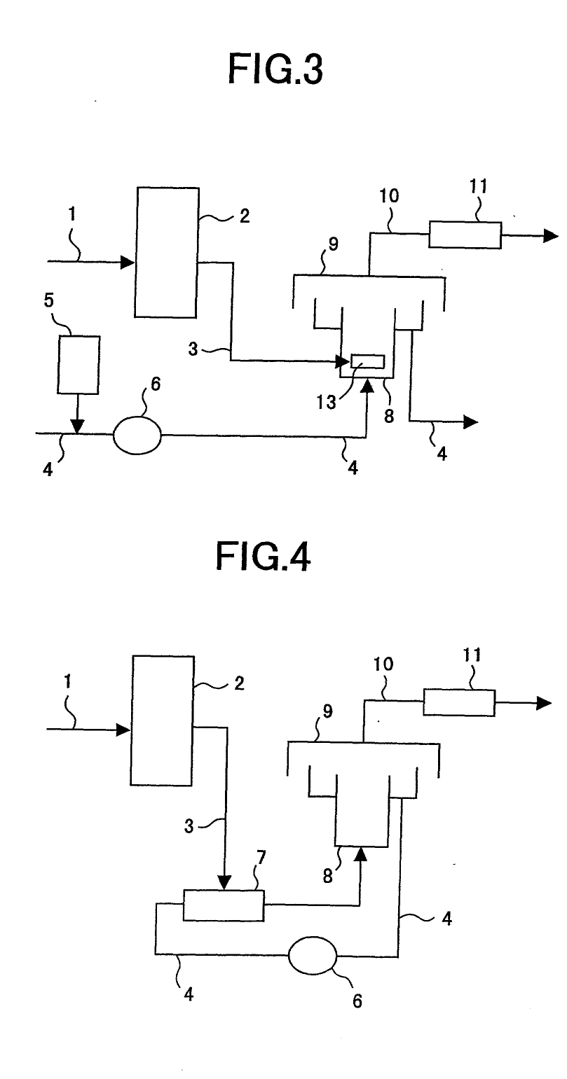

FIG. 3 shows a system flow showing a washer of an embodiment 3. In this figure, reference numeral 13 designates diffusing equipment arranged within the washing water reservoir 8 and diffusing ozone from an ozone supply source into the washing water reservoir.

In the embodiment 3, washing water 4 including alkali bromide is supplied to the washing water reservoir 8. In contrast to this, ozone gas 3 generated in an ozone gas generator 2 is supplied to the diffusing equipment 13 arranged within the washing water reservoir. The ozone gas 3 supplied from the diffusing equipment 13 and the alkali bromide included in the washing water 4 generate a reaction product within the washing water reservoir 8.

Here, both the ozone gas undissolved into the washing water 4 and the reaction product exist within the washing water reservoir 8.

Accordingly, in accordance with the embodiment 3, a washed object can be washed by both the undissolved ozone gas and the reaction product so that washing ability can be improved.

### Embodiment 4

FIG. 4 shows a system flow showing a washer of an embodiment 4. In comparison with FIG. 1, alkali bromide solution injecting equipment 5 is removed. Further, a washing water circulating path is arranged to circulate and use washing water 4. In the embodiment 4, the alkali bromide is dissolved into pure water in advance with respect to the washing water 4. This alkali bromide is desirably set to approximately have a concentration from 1 to 10%.

Since the washing water 4 includes the alkali bromide in the embodiment 4, ozone gas 3 is efficiently dissolved in a gas mixer 7 and a reaction product of ozone and the alkali bromide is generated. The washing water 4 discharged from the gas mixer 7 is supplied to a washing water reservoir 8, and washes a washed object within the washing water reservoir. The reaction product is consumed by this washing, and the reaction product is returned to the original alkali bromide. The washing water 4 consumed with respect to the reaction product is circulated by a pump 6 and is again supplied to the gas mixer 7. In the gas mixer 7, the ozone gas is supplied to the washing water 4 and the reaction product is again generated.

Accordingly, in accordance with the embodiment 4, the washing water is circulated and used. Therefore, even when a large amount of washing water is required, the amount of washing water actually used can be restrained and running cost can be reduced.

Further, since it is not necessary to continuously replenish the alkali bromide as in the embodiment 1, a consumed amount of alkali bromide can be reduced.

No alkali bromide solution injecting equipment for supplying the alkali bromide is also required.

In this embodiment, a washing method is also explained by way of explaining the operation of the washer. This washing method is characterized in that the washing water used in the washing is circulated and ozone is again supplied to the circulated washing water. Thus, running cost can be reduced.

### Embodiment 5

FIG. 5 shows a system flow showing a washer of an embodiment 5. In the embodiment 5, a gas-liquid separating reservoir 12 is applied to the embodiment 4.

In the embodiment 5, ozone gas 3 generated in an ozone gas generator 2 is injected to a gas mixer 7, and is mixed with washing water 4 circulated by a pump 6. The washing water 4 flowed out of the gas mixer 7 is flowed into the gas-liquid separating reservoir 12, and is separated into exhaust ozone gas 10 and washing water 4 in this gas-liquid separating reservoir 12. The separated exhaust ozone gas 10 is sent to an exhaust ozone decomposing tower 11, and is decomposed into harmless oxygen and is then exhausted to the system exterior. In contrast to this, the separated washing water 4 is supplied to a washing water reservoir 8, and washes a washed object by a reaction product of ozone and the alkali bromide.

Unlike ozone, this reaction product is odorless.

Accordingly, in accordance with the embodiment 5, in addition to the effects of the embodiment 4, the ozone odor can be removed so that an environment around the washing water reservoir can be improved.

Further, in accordance with the embodiment 5, no exhaust equipment is required around the washing water reservoir so that it is not necessary to arrange large exhaust equipment as the washing water reservoir is large-sized.

### Embodiment 6

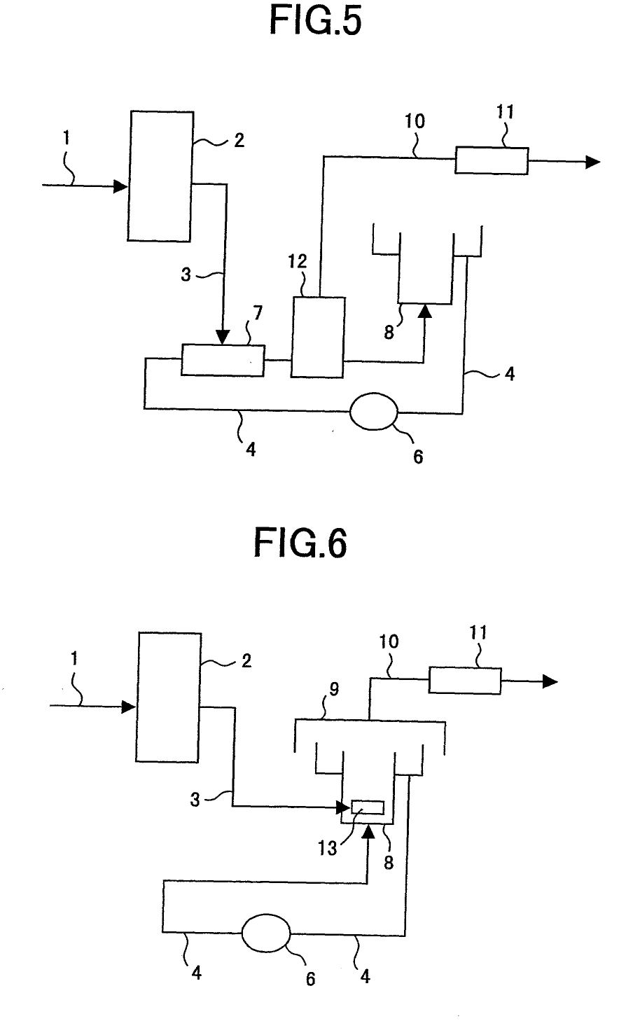

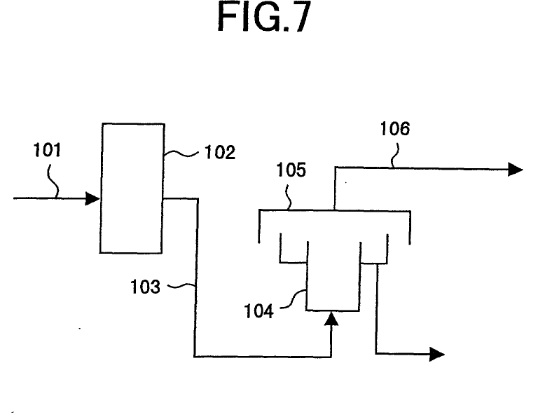

FIG. 6 shows a system flow showing a washer of an embodiment 6. In the embodiment 6, diffusing equipment 13 is applied to the embodiment 4.

In the embodiment 6, ozone gas 3 generated in an ozone gas generator 2 is supplied to the diffusing equipment 13 arranged within a washing water reservoir 8. In the washing water reservoir 8, the ozone gas 3 and washing water 4 injecting alkali bromide thereinto in advance react so that a reaction product is obtained. Here, a pump 6 is operated to efficiently mix the washing water 4 and the ozone gas 3. The ozone gas undissolved into the washing water 4 is used in the washing within the washing water reservoir.

Accordingly, in accordance with the embodiment 6, in addition to the effects of the embodiment 4, a washed object can be washed by both the ozone gas and the reaction product so that washing ability can be improved.

In the above embodiment, a washing method is also explained by way of explaining the operation of the washer.

The embodiments are merely examples of the invention. The invention is not limited to the above embodiments, but can be variously modified within the scope of the spirit of the invention.

As mentioned above, in accordance with the washer of this invention, the washing water of high concentration can be easily obtained, and duration of the washing ability can be lengthened.

Further, in accordance with the washer of this invention, the ozone odor is restrained around the washing water reservoir, and no large exhaust equipment is required around the washing water reservoir.

Further, in accordance with the washer of this invention, even when a large amount of washing water is required, the washing water can be effectively utilized and a rise in running cost can be restrained.

Further, in accordance with the washing method of this invention, the washing water of high concentration can be easily obtained and duration of the washing ability can be lengthened.

Further, in accordance with the washing method of this invention, even when a large amount of washing water is required, the washing water can be effectively utilized and a rise in running cost can be restrained.

What is claimed is:

1. A washer comprising ozone dissolving equipment for dissolving ozone supplied from an ozone supply source, into washing water, and a washing water reservoir for storing the washing water including said ozone and dipping a washed object into the stored washing water, wherein said washing water includes an alkali bromide.

2. A washer according to claim 1, wherein the alkali bromide approximately has a concentration from 1 to 10%.

3. A washer according to claim 1, wherein the washer further comprises an alkali bromide supply source for supplying the alkali bromide to the washing water before this washing water flows into the ozone dissolving equipment.

4. A washer according to claim 1, wherein the washer further comprises a gas-liquid separator for separating the washing water flowed out of the ozone dissolving equipment into a gas and a liquid, and an ozone purifying device for purifying ozone separated into the gas phase.

5. A washer according to claim 1, wherein the washer further comprises diffusing equipment arranged within the washing water reservoir and diffusing the ozone from the ozone supply source into the washing water reservoir.

6. A washer according to claim 1, wherein the washer further comprises a washing water circulating path for supplying the washing water flowed out of the washing water reservoir to the ozone dissolving equipment.

7. A washing method comprising a step for supplying ozone to washing water including an alkali bromide, and a step for washing a washed object with a reaction product of said alkali bromide and said ozone.

8. A washing method according to claim 7, wherein the washing method further comprises a step for circulating the washing water used in the washing, and a step for again supplying ozone to this circulated washing water.
